(19) United States
(12) Patent Application Publication
(10) Pub. No.: US 2022/0113699 A1
(43) Pub. Date: Apr. 14, 2022

(54) AUTONOMOUS AGENT OPERATION ADAPTION BASED ON ENVIRONMENTAL RISK

(71) Applicant: Intel Corporation, Santa Clara, CA (US)

(72) Inventors: Cornelius Buerkle, Karlsruhe (DE); Bernd Gassmann, Straubenhardt (DE); Florian Mirus, Eppelheim (DE); Fabian Oboril, Karlsruhe (DE); Frederik Pasch, Karlsruhe (DE); Kay-Ulrich Scholl, Malsch (DE)

(21) Appl. No.: 17/559,455

(22) Filed: Dec. 22, 2021

(51) Int. Cl. G05B 19/4061; G05B 19/418; G06Q 10/00

(52) U.S. Cl. CPC G05B 19/4061; G06Q 10/20; G05B 19/4183; G05B 19/41895

(57) ABSTRACT

A computing device, including: a memory configured to store computer-readable instructions; and processing circuitry configured to execute the computer-readable instructions to cause the computing device to: generate an environmental condition model (ECM) based on collected environmental attribute data of a physical environment; deploy the ECM to estimate environmental risk for an autonomous agent based on the environmental attribute data and a position of the autonomous agent within the physical environment; and transmit information related to the estimated environmental risk to the autonomous agent to adapt its operation to reduce operational risk.

### TECHNICAL FIELD

Aspects described herein generally relate to safe operation of autonomous agents and, more particularly, to techniques to adapt behavior of autonomous agents based on individualized operational risks in an environment.

### BACKGROUND

Autonomous agents (autonomous mobile robots (AMRs)) deployed in indoor warehouse or factory environments generally cannot avoid pollutants such as dirt on the floor, emissions in the AMR working area, or water left from cleaning. And AMRs operating in outdoor environments encounter rain, snow, ice, mud, and air pollution in forms such as precipitation and dust.

Pollutants in an environment negatively impact safe operation of AMRs. Air pollution, such as dust and aerosols, degrade an AMR's sensor and perception system performance, cause ghost objects in LiDAR (light detection and ranging) and radar processing, and blur camera images. Further, a wet or dirty floor decreases friction between the AMR's wheels and the floor surface such that aggressive braking or directional change maneuvers of the AMR result in loss of control, thereby increasing the risk of an accident.

### BRIEF DESCRIPTION OF THE DRAWINGS

FIG. 1 illustrates a process flow for edge-based AMR behavior adaption on environmental risks in accordance with the disclosure.

FIG. 2 illustrates a process flow of environmental condition estimation in accordance with the disclosure.

FIG. 3 illustrates a process flow of environmental risk estimation of AMR and adaption of its driving behavior in accordance with the disclosure.

FIG. 4A illustrates potentially hazardous interdependency examples in accordance with the disclosure.

FIG. 4B illustrates extended safety envelope for welding AMR example in accordance with the disclosure.

FIG. 5 is a graphical representation of contributions to protective separation distance between operator and AMR in accordance with the disclosure.

FIG. 6 illustrates a process flow of environment-dependent risk assessment in accordance with the disclosure.

FIG. 7 illustrates an example of a dependency tree in accordance with the disclosure.

FIG. 8 illustrates a layered map for different attributes in accordance with the disclosure.

FIG. 9 illustrates a block diagram of an exemplary computing device agent in accordance with the disclosure.

### DESCRIPTION OF THE ASPECTS

The present disclosure is directed to collecting and combining environmental condition information (e.g., state of the floor surface or pollution level in the air) in a crowd-sourced manner using edge sensors, AMR sensors, maintenance AMR data, and/or manually-entered cleaning staff data. This information is used to create and maintain within the Edge/cloud an environmental condition model (ECM) of an entire facility and distribute relevant information.

Based on the ECM, individualized risks for AMRs (e.g., slippery floors and limited visibility/perception degradation) are derived. The risks are provided to the AMRs, for example, in form of a heat map. The AMRs then deploy the risk information to adapt their behavior for safer operation under environmental conditions that may be difficult to detect for the individual AMRs. The AMRs constantly receive updates of the heat map at their current location, so they can dynamically adapt their behavior to the actual risk in the respective area by lowering their speed, planning for larger braking distances and higher perception uncertainties, and/or avoiding high risk areas completely if possible. Furthermore, the collected information is deployed, for example, as a heat map, to provide individual warnings for persons in the surrounding of a slippery/dangerous area, as well as to automatically trigger cleaning service on demand.

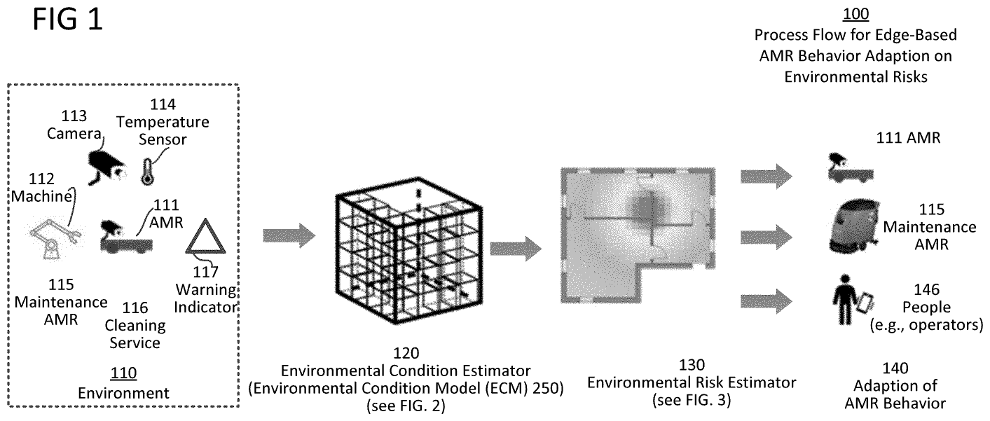

FIG. 1 illustrates a process flow 100 for edge-based AMR behavior adaption on environmental risks in accordance with the disclosure.

By way of overview, the process flow may be executed by processing circuitry configured to execute computer-readable instructions to cause a computing device to: (1) generate, by an environmental condition estimator 120, an environmental condition model (ECM) based on collected environmental attribute data of a physical environment 110; (2) deploy, by an environmental risk estimator 130, the ECM to estimate environmental risk for an AMR based on the environmental attribute data and a position of the AMR within the physical environment 110; and (3) transmit information related to the estimated environmental risk to the AMR to adapt its operation to reduce operational risk 140.

The environment 110 may include one or more AMRs 111, operating machines 112, sensors such as cameras 113 and temperature sensors 114 monitoring the operation within the environment 110, maintenance AMRs 115 and human cleaning services 116 for maintaining the environment 110, warning indicators 117, and the like.

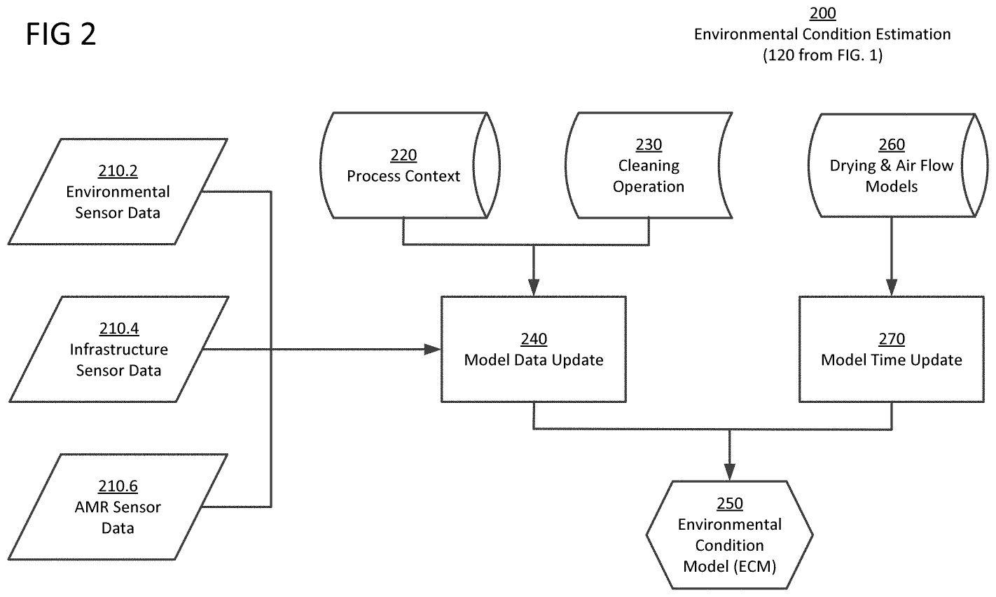

I. Environmental Condition Estimator 120 (See FIG. 2 for Detail)

The environmental condition estimator 120 collects and fuses environmental attribute data in a crowd-sourced manner from one or more AMR sensors, one or more infrastructure sensors, and/or manually-reported condition information into the ECM of the facility/operation environment 110 and updates the state estimate over time. The ECM is generated or deployed at least partially within the Edge or the cloud.

Different attributes may be stored by the ECM describing parameters relevant for the AMR operation environment 110. The ECM might be represented in form of a two-dimensional, or if high-level accuracy is required, a three-dimensional grid. Other representations of the geometrical operation environment 110 are also feasible.

A. Model Data Update

The ECM may represent the estimated environmental risk information in a form of a grid map of cells corresponding with the physical environment 110 and having one or more layers corresponding with respective environmental attributes. Each cell of the grid stores attributes comprising the measurement inputs from the different information sources as well as derived state estimates. The attributes may include smart environmental sensor information, and sensor data from infrastructure sensors and/or AMR sensors.

The smart environmental sensor information may include temperature, humidity, and/or airflow. Alternatively or additionally, the environmental sensor information may include smoke or special gas detected information to protect the load of AMRs 111 or support warning of persons about dangerous gases. Alternatively or additionally, the sensor information may include lighting conditions on which camera-based perception quality depends.

The data of the sensors located within the infrastructure or attached to the AMR 111, such as RGB cameras, infrared cameras, depth cameras, LIDARs, and the like, may be deployed to meet any of a number of objectives. A floor state (e.g., wet, particles) may be classified, and if possible, the kind and amount/level of dirt/particles. Air pollution (dust, aerosol) may be estimated. Observed degradation/quality effects, which intelligent sensor might provide, may be reported. And traffic within the area, such as persons, vehicles as well as AMRs 111, may be observed.

The condition of the floor surface may be estimated directly based on distance data collected from an odometer or acceleration data from an accelerometer of the AMR 111, in combination with the AMR's 111 actual movement, where the AMRs 111 are losing traction. This input may be stored as a measured friction state.

The ECM is updated over time with additional collected environmental attribute data, and the measurement times of the respective collected environmental attribute data, including the additional collected environmental attribute data, are stored. The timestamp of the last measurement of these cell attributes may be stored to differentiate between measurements having a regular update rate and outdated measurements.

The collected environmental attribute data may be combined with additional knowledge of the machines 112 and/or the production process to improve the estimates, because the visual sensor data alone often is not sufficient. For example, it may be difficult to differentiate between an observed fluid being water rather than oil. The additional knowledge might make, for example, sawdust, sweat secretion, oil leakages of machines/AMRs 111 more likely at some places than at others. Another example of production context to be deployed might be forklifts driving outside in the rain and bringing water back inside upon return.

Also, if the sensors (e.g., cameras 113) observe cleaning efforts in an area, the amount of water expected on the floor will increase, whereas dust, oil and other dirt probabilities will decrease. To support these observations, maintenance AMRs 115 might even provide support for indoor-localization tags or clear visible markers 117 to improve these estimates. Cleaning staff/AMRs 115 may also directly report the area they cleaned back to the environmental condition estimator 120.

B. Model Time Update

In general, the environmental condition estimator 120 may take temporal effects into account. Water on the floor dries over time. A drying model D applied might become more exact if information on current temperature T, humidity H, and air flow A are available via actual measurements, however, estimates might also be sufficient. The time update of a cell's water level attribute wₜ might be formulated as:

$${w}_{t} = f ( {w}_{t - 1} , D , T , H , A , Δ t ) \qquad ( 1 )$$

The estimated drying model parameters may also be updated over time in case the observed drying effects do not match the predicted or expected effects in order to constantly improve and adapt the drying model to the current situation. In a similar manner, the estimated or measured flow of air can be deployed to simulate the spreading of particles in the air over time and increase the accuracy of the ECM. Other effects to be considered over time include dropping outdated measurements (e.g., the above-mentioned direct friction estimate of a slipping AMR 111) to ensure their influence on the final environmental risk estimation (described below) is decreased over time.

FIG. 2 illustrates a process flow of environmental condition estimation 200 performed by the environmental condition estimator 120 of FIG. 1 in accordance with the disclosure.

The ECM 250 is updated constantly when data is received, and may factor in the model data update 240 and the model time update 270 discussed above.

The model data update 240 factors in environmental sensor data 210.2, infrastructure sensor data 210.4 and/or autonomous agent sensor data 210.6. The model data update 240 may also factor in process context 220 in the environment 110. Additional data on a cleaning operation 230 may be incorporated into the ECM directly.

The model time update 270 is performed considering the temporal effects on environmental attribute, such as drying and/or air flow. The model time update 270 is based on drying and air time models 260. Also, the temporal effect due to drying time or air flow impacts estimated or measured drying model parameters or air flow parameters of the ECM.

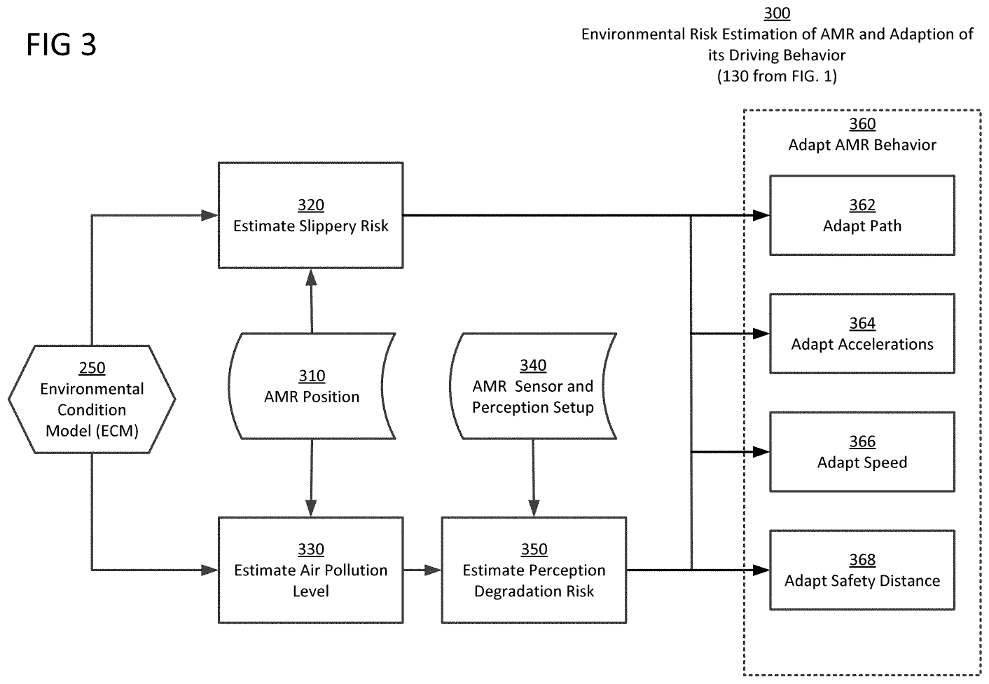

II. Environmental Risk Estimator 130 (See FIG. 3 for Detail)

Based on the ECM, the environmental risks for different applications may be estimated (e.g., slippery risk or visibility degradation). These risks may be either estimated on-the-fly for the respective map area of interest, collected within a separate multi-layered map, or be considered as additional layer of the ECM.

The additional layer might only be feasible if both the ECM as well as the specific environmental risk map (e.g., slippery risk map) have the same dimensionality. The ECM might be stored in three dimensions to support multiple tasks at once, but the slippery risk map for an AMR 111 may be required to be maintained in two dimensions.

The environmental risk estimator 130 deploys the ECM on-the-fly to estimate the associated environmental risk at agent level to be able to adapt the AMR behavior dynamically to the current local environmental risk level. Alternatively and/or additionally, the environmental risk estimator 130 may trigger, based on the collected environmental attribute data and a position of another agent or object within the physical environment, a warning about a dangerous condition. Alternatively and/or additionally, the environmental risk estimator 130 may trigger, based on the collected environmental attribute data, a maintenance AMR 115 or a human maintenance service 116 to clean at least a portion of the physical environment on demand.

The respective environmental risk depends on different factors. For example, the slippery risk sr(t) might be calculated based on the grid cells water level w(t), dirt level d(t), oil level o(t) attributes and corresponding slippery factors/models of each (W, D, O) as well as the measured friction estimate fr(t) of AMRs 111 driving within that grid cell previously:

$$s r ( t ) = w ( t ) W + d ( t ) D + o ( t ) O + f r ( t ) \qquad ( 2 )$$

considering a respective aging factor F_{fr} of the measured friction estimate based on the time elapsed between the last measurement time t₀:

$$f r ( t ) = f r ( {t}_{0} ) {e}^{- {F}_{f r} ( t - {t}_{0} )} \qquad ( 3 )$$

Thereby, the slippery risk for different agents might be calculated in a different way if the movement kinematics differ (e.g., omni-wheeled AMR versus a classic four-wheeled AMR).

To obtain a notion of the visibility degradation within the respective areas, AI model(s) (or classifiers) might be trained on the camera images and/or the LIDAR data provided by the edge/AMR sensor data to either provide direct output of the expected degradation level for perception algorithms or indirectly estimate the pollution level within the air or the observed lighting conditions (if not measured by other means). The later decouples the estimation of the air/light quality from the degradation effect the pollution/brightness has on a specific AMR 111. The visibility degradation risk vr(t) might then be estimated in a similar way as the slippery, e.g., based on the lighting level l(t) and the pollution level p(t) and AMR specific degradation factors/models of each (L, P):

$$v r ( t ) = l ( t ) L + p ( t ) P \qquad ( 4 )$$

The air pollution level might also consider an aging effect with aging factor Fₚ as well as a dependency on the cumulated airflow a(t) observed as follows:

$$p ( t ) = p ( {t}_{0} ) {e}^{- {F}_{p} ( t - {t}_{0} ) {\int }_{{t}_{0}}^{t} a ( x ) d x} \qquad ( 5 )$$

while this might only become relevant in areas where the air pollution level cannot be updated on a regular or timely basis.

III. Adaption of Autonomous Agent Behavior 140

The relevant environmental risk maps are shared with the corresponding AMRs 111 to allow them to adapt their behavior to reduce their overall operational risk. Mobile as well as stationary AMRs 111 that base their task on the perceived sensor data might perform more cautious actions and reduce their operating speed if the pollution level in their operation area distracts their perception system due to bad visibility. The behavior planning and task execution can consider the increased environmental risk level, for example, by increasing uncertainties in the perceived environment or by extending safety distances 368 to other AMRs 111, objects, or persons.

FIG. 3 illustrates a process flow 300 of environmental risk estimation of AMR and adaption of its driving behavior 360 performed by the environmental risk estimator 130 of FIG. 1 in accordance with the disclosure.

Based on the ECM 250 and the AMR's position 310, the slippery risk in the relevant area is estimated 320. Depending on the slippery risk 320, the AMR 111 might replan its path 362 and/or adapt its planned speed 366 and/or accelerations 364. In areas that are slippery, AMRs 111 can lower their speeds 366, or consider smoother braking or direction change maneuvers 362 to reduce the risk to lose control of their motion. Based on the slippery of the ground, they even might be able avoid risky areas completely by planning other paths to their target 362. Furthermore, humans may be agents, which can receive either individual warnings on a slippery area via, for example, a smartphone device, mounted displays/indicators, or audible warnings via speaker systems (e.g., “Be careful: wet floor ahead”).

Also, the management of the maintenance service 116, 115 may be considered an agent. If dirty areas or slippery floor (not caused by cleaning itself) is detected, maintenance staff 116 or maintenance AMRs 115 may be sent out for demand-oriented maintenance. The required environmental risk map for this case will hold a risk for the required maintenance effort.

Alternatively and/or additionally, the air pollution level in the relevant area is estimated 330. And considering this estimated air pollution level 330 and the AMR's sensor/perception setup 340, the risk of degradation of its perception system is estimated 350. Depending on this risk, the AMR 111 adapts its speed 366 and safety distances 368.

Dynamic adaption of AMR behavior to current environmental conditions improves safety. Overall risk is reduced with little to no impact on the usability of the AMRs 111. Facilities are becoming smarter with increased installations of edge-based camera systems used for other purposes. Mitigation of risks is therefore feasible with minimal extra effort. And no human interaction required. The environmental condition processing occurs mainly within the edge, so the required compute may be supported by off-the-shelf hardware. Furthermore, an up-to-date warning service for slippery floors for persons is available. This becomes even more attractive in combination with automated maintenance AMRs 115.

IV. Extensions

The floor state can be extended by other states relevant for AMR driving, such as non-traversable holes, open drains, low load-bearing capacity areas to ensure safe operation of the AMR 111.

Also, the aspects of this disclosure are not restricted to indoor environments. The aspects may be applied outdoor environments where a slippery state of the ground is influenced by temperature, ice, snow, and/or air pollution in all forms of precipitation or dust.

V. Environment-Dependent Risk Assessment

Existing systems typically consider only collision risk. Some systems consider only distance. When considering easily inflammable objects and a heat source, such as a welding tool, a direct collision is not required to cause an object to catch fire.

The aspects of this disclosure may estimate an individual risk of another agent or object in the physical environment 110, estimate a potentially hazardous environment-dependent interdependency between the AMR 111 and the other agent or object, and enhance a safe working envelope of the AMR 111 due to the estimated interdependency. The potentially hazardous environment-dependent interdependency between the AMR 111 and the other agent or object is based on a reactivity between the AMR 111 and the other agent or object. The reactivity may be based on a material property or a physical environment position of the AMR 111 or the other agent or object. And the reactivity is a function of severity or probability of a reaction between the AMR 111 and the other agent or object.

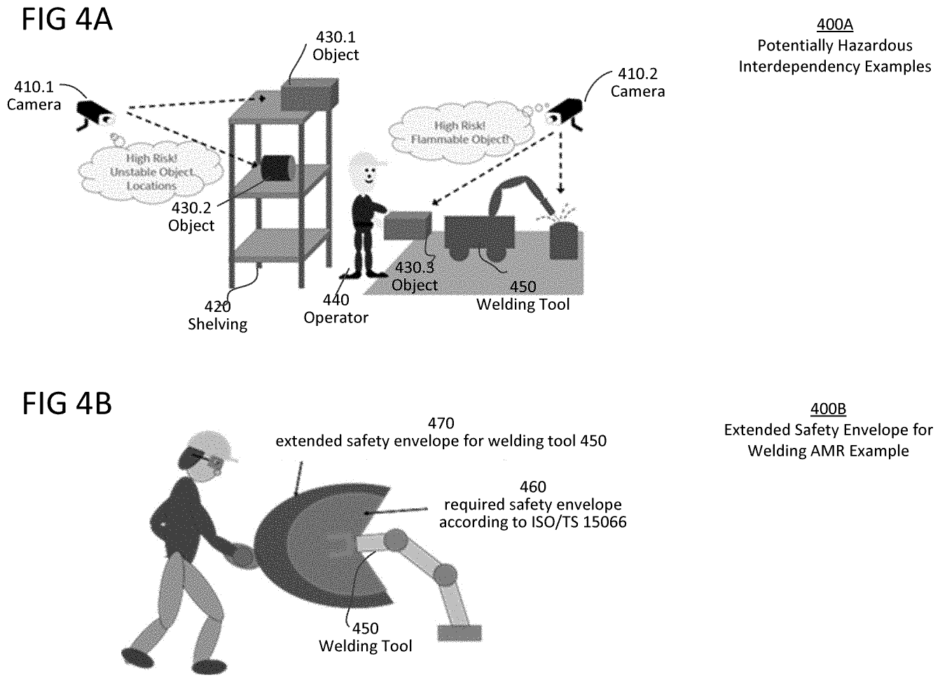

FIG. 4A illustrates potentially hazardous interdependency examples 400A. A human operator 440 is about to put a cardboard box 430.3 proximate an AMR welding tool 450 performing a task producing heat and emitting flaming sparks. The cardboard box 430.3 on its own does not pose increased risk, but by bringing the box 430.3 near the welding tool 450, the risk of the box 430.3 burning increases drastically. The increased risk through the potentially hazardous interdependency of the cardboard box 430.3 and the welding tool 450 can be detected and avoided by increasing the safety distance between the welding tool 450 and the flammable cardboard box 430.3 from would otherwise would have been required for an object that is heat-resistant.

FIG. 4B illustrates an extended safety envelope for the welding tool example. The reactivity between objects/agents are taken into account when calculating the required safety envelope 470. The welding AMR 450 requires an enhanced safety envelope 470 compared to the standard ISO/TS 15066 safety envelope 460 used to simply avoid collisions.

A. Reactivity Sensible Safe Distance

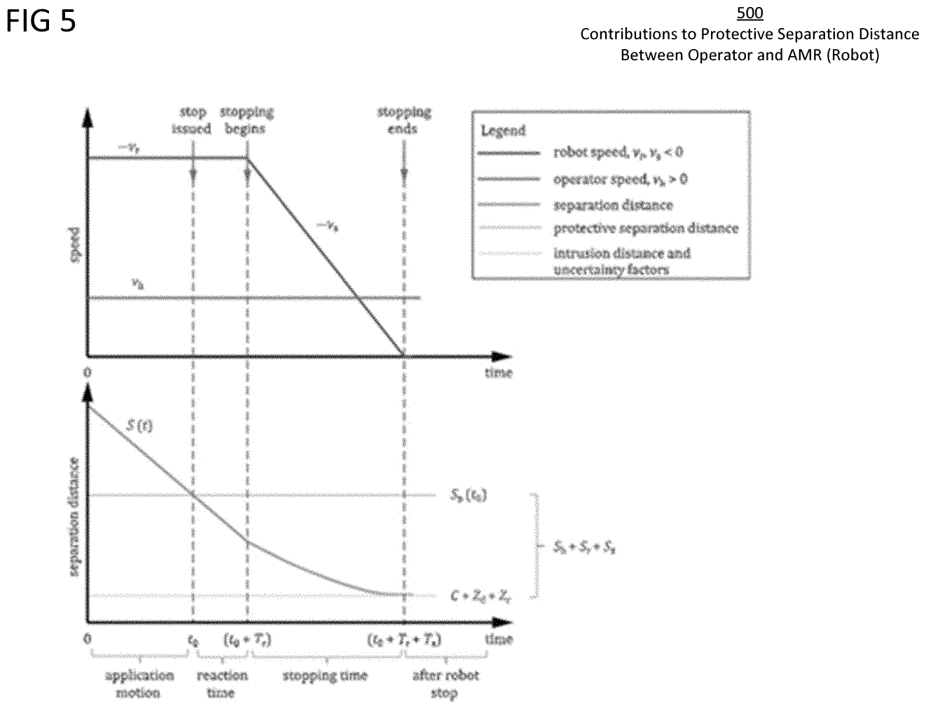

FIG. 5 is a graphical representation 500 of contributions to protective separation distance between an operator and an AMR (robot) in accordance with the disclosure.

Safe distance between an object and a robot is usually defined such that a foreseeable motion of both entities does not result in a collision, or in other words, that the AMR can cease motion before colliding with another agent, an object, or a human.

To check if the robot's state is safe, a distance between the object and robot must be greater than the safe distance. If the motions of both robot and object (other) are known, or at least a model is available that can be used to provide a worst-case assumption, the safe distance ∂_{safe} with a function f can be calculated, for example, in alignment with the ISO T515066. Input to f is the state of the robot S_{robot} and state of the object Sₒₜₕₑᵣ as follows:

$${\partial }_{s a f e} = f ( {S}_{robot} , {S}_{other} ) \qquad ( 6 )$$

As already described, a dangerous reaction can happen even before an actual collision occurs. For instance, a heat source can ignite an inflammable object before there is direct contact. Thus, the distance ∂_{reaction} can be calculated using the function r based on the materials M of the two objects as follows:

$${\partial }_{reaction} = r ( {M}_{robot} , {M}_{other} ) \qquad ( 7 )$$

The reaction distance a ∂_{reaction} is a measure for the maximum distance within which a reaction between the two materials is likely or possible. The severity of the reaction has to be considered (e.g., money loss but no human injury, light human injury, up to possible fatal reactions). Finally, the distance can be obtained as a function of severity and probability. In this regard, an acceptable severity and associated acceptable probability are defined. For instance, if the probability of light injuries should be lower than 10⁻⁶, the required distance can be obtained in accordance with bio-physical/chemical models or predefined lookup tables. To illustrate this process, imagine a welding flame and a human limb. The injury over distance function will follow an S-shape curve, and the goal is to obtain the distance that satisfies the aforementioned requirements. This is reaction distance ∂_{reaction}.

The material state M can contain several attributes such as chemical material and temperature. Thus, the overall required safe distance a ∂ₒᵥₑᵣₐₗₗ is:

$${\partial }_{overall} = {\partial }_{safe} + {\partial }_{reaction} \qquad ( 8 )$$

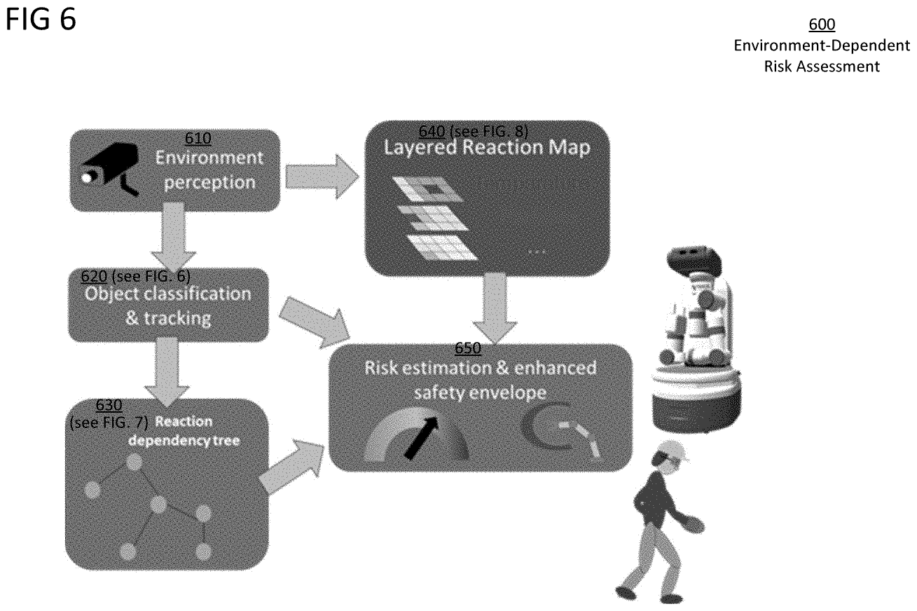

FIG. 6 illustrates a process flow of environment-dependent risk assessment 600 in accordance with the disclosure.

By way of overview, the environment-dependent risk assessment 600 may include evaluation of potentially hazardous interdependencies of objects and even persons depending on the environment. The risk assessment and safety standards are expanded to situations that could be harmful even without a collision. Potentially hazardous interdependencies are detected in order to calculate an extended safety envelope 470. In addition, the risk of objects/agents depends on their environment as well as potentially hazardous interdependencies.

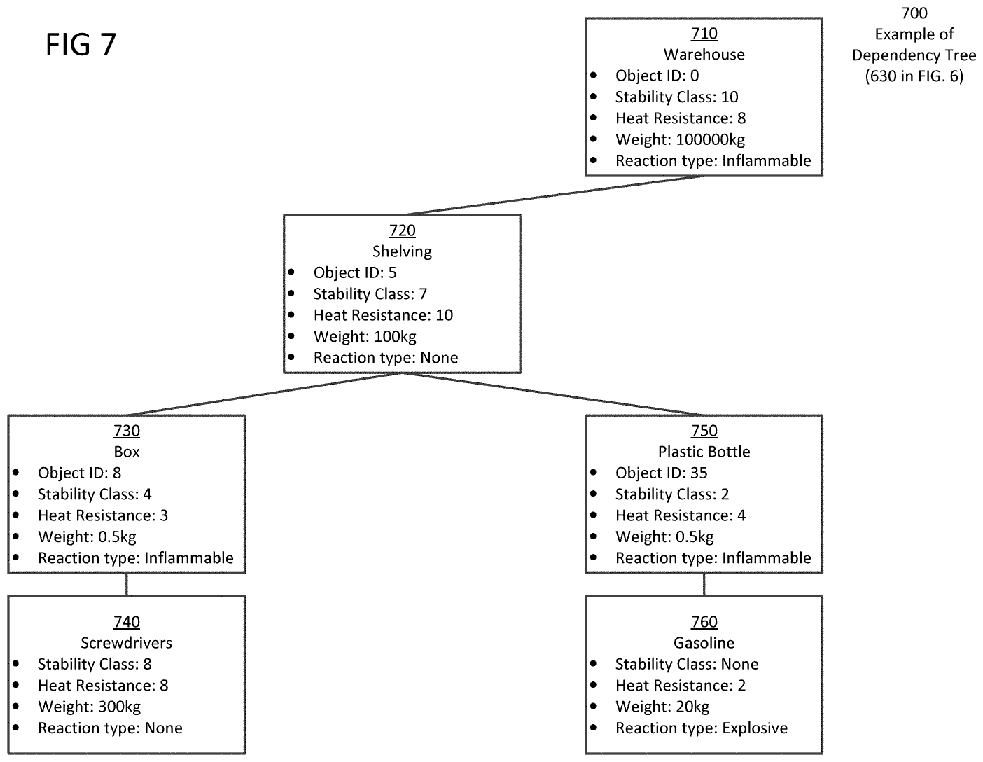

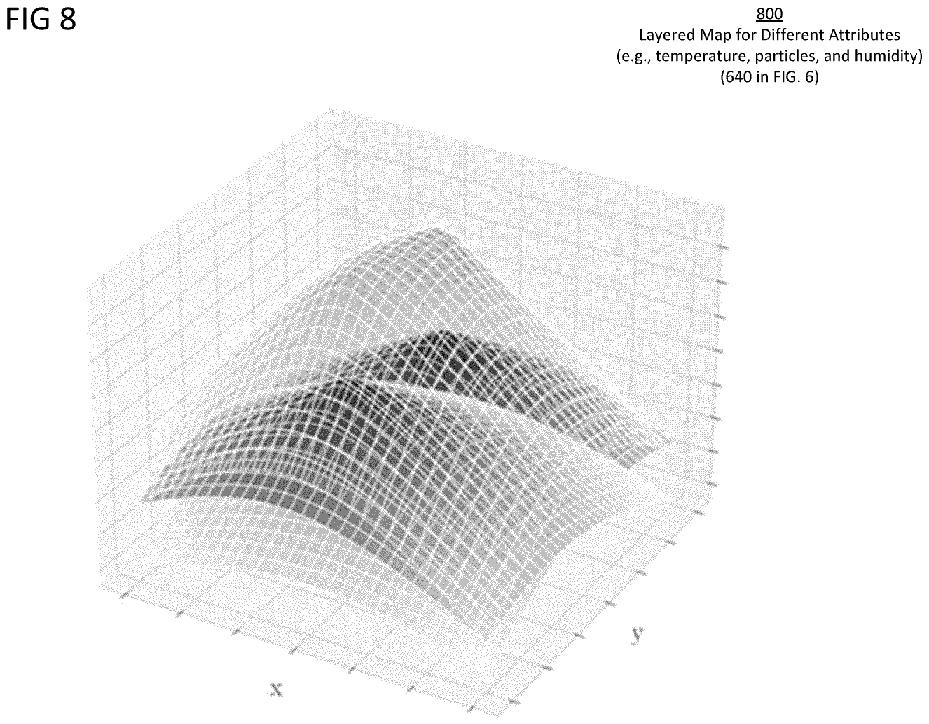

The environment-dependent risk assessment 600 includes environment perception 610, object classification and tracking 620, forming a reaction dependency tree 630 (detail shown in FIG. 7), creating a layered reaction map 640 (detail shown in FIG. 8), and risk estimation and enhanced safety envelope 650.

B. Environmental Monitoring 610, and Object Classification and Tracking 620

The environment 110 is perceived through smart infrastructure sensors (e.g., cameras 410) and optionally an AMR's on-board sensors (not shown) (process step 610). Objects 430 and/or other agents are detected, classified and tracked (process step 620), and their individual risks are estimated. For instance, an ill-positioned object 430 in a path or an object 430.1 located high on shelving 420 increases the risk of injuries to an operator 440. In contrast to existing solutions, potential hazards, which do not necessarily arise from collisions but from environment-dependent interdependencies, are considered through an extended safety envelope 470, which is larger than an otherwise required safety envelope.

The environment 110 is monitored through smart sensors (infrastructure and AMRs 111). Any object in the environment 110 is usually described by its state S_{object}. This state contains information not only about position and dimension, but also class attributes. In the end all information to physically interact with the object 430. The state is extended by a classification of the object material M_{object}. For instance, the material could be the property of the surface, whether it is a carton box or a glass bottle. However, the material information is not limited to the surface, but may also include the content, such as gasoline, hydrochloric acid, and the amount of the content. Furthermore, additional information may be the current temperature or even the possibility of causing chemical reactions by emitting sparks while moving.

These object properties can be either retrieved from an internal database, for instance, the warehouse management system, which stores properties of the in-stock goods. Additionally, the information can be shared via communication such that an AMR 111 can communicate internal states and materials with the system and/or other AMRs 111. Furthermore, such material information could be perceived through sensors in the infrastructure or on the AMRs 111. For instance, camera sensors could detect information such as warning signs, hazard icons, and material classification. There could also be dedicated sensors such as thermometers, humidity or infrared sensors detecting relevant information about the scene or objects. Besides the material, an object detector may be trained to detect if objects and goods in the environment are unstable. For instance, such unstable objects could be a bottle placed at the edge of a shelf 420, even an unstable shelf 420 itself.

C. Reaction Dependency Tree 630

FIG. 7 illustrates an example of a dependency tree 700 in accordance with the disclosure.

Besides the standard environmental model, the additional dependency tree 700 defines the relationships between the objects 430 in the environment (warehouse 710). The tree 700 could be a hierarchical tree-like structure describing what is inside an entity. The tree 700 is updated whenever an object is moved, for example, a box 730 taken off shelving 720 or a new box 730 inserted. Based on the dependency tree 700, the probability and severity of different types of reactions are derived.

The severity of a reaction P_{reaction} is determined by two factors—the probability that a relevant reaction occurs and the severity of the reaction. The probability is determined by the resistance of the object against the type of reaction, for instance, heat resistance or stability. For instance, a collision with the wall of a warehouse up to a certain impact velocity is no threat to the warehouse itself. On the other hand, the same collision impact could knock over a shelf. Thus, the probability is dependent on the constellation between the objects and the possible reactions of the objects. The final probability is influenced by force of the impact in relation to the resistance of the hit object. The potential reaction P_{reaction} may be defined as follows:

$${P}_{reaction} = P ( {S}_{A} , {M}_{A} , {S}_{B} , {M}_{B} ) \qquad ( 9 )$$

To determine the resistance of an object, it is important to consider the entities inside the object. For instance, the stability of shelving 720 will be decreased if it is not loaded properly. The other important aspect is the severity of a reaction. For instance, a collision knocking down shelving 720, which could fall on a human or cause braking of bottles 750 with toxic chemicals 760 inside or an explosion will cause additional follow-up reactions such as fire.

The reaction dependency includes conducting a reaction evaluation for any entity of the tree 700. Hence, for a given reaction the overall resistance and possible reactions of all ingredients are determined. For instance, for a bottle 750 this is the reaction of the bottle 750 itself plus the reaction of the content 760. For shelving 720 filled with bottles 750, this will be the reaction of the shelving 720 and reaction of all bottles 750 on the shelving 720. For some situations, resistance might be resistance of the shelving 720, but even for a smaller impact, there is the chance of objects falling down, so overall resistance against impact might be reduced. This reaction evaluation is in the end a function of possible reactions between the objects, the overall resistance and potential down-stream reactions represented as follows:

$${w}_{react} ( {O}_{1} , {O}_{2} ) = f ( reaction , resistance , downstream ) \qquad ( 10 )$$

These reaction evaluation are represented as weights of the edges in the dependency tree 700 to allow easy evaluation of potential reactions of several objects connected over multiple branches in the tree 700. Additionally, with rules of physics and chemistry this will allow estimation of the energy of the reaction and the impacted region. The overall severity can be calculated based on the calculated resistance, reaction, impacted region and objects within the impacted region. For severity estimation, it might not be required to take all possible consequences into account. A decision of severity classes like S0 (no consequence) up to S3 (fatal consequence) might be sufficient. These combinations could be achieved by simulation-based methods, but there could be also a trained system that is able to predict the required values.

The values shown in boxes 710, 720, 730, 740, 750, 760 of the dependency tree 700 are merely examples and not intended to be limiting.

D. Layered Reaction Map 640

FIG. 8 illustrates a layered map 800 for different attributes in accordance with the disclosure. These attributes may include, for example, temperature, particles, and/or humidity

To estimate the location and motion of workers and AMRs 111, modern systems typically employ probabilistic approaches such as Kalman or Particle filters to create an accurate model of all relevant objects and areas. There might be environmental effects that cannot be directly described by objects, such as heat distributions in the environment around a melting oven, or areas with extreme could around a cooling system or inside a fridge. Potential gas leaks or areas of dust might fall into this category. A layered risk map 800, where each cell corresponds to a physical location and the environmental effect is stored, may capture these effects.

Not only can the interaction between objects cause a reaction, but also the environment itself has a certain probability of influencing or causing reactions. The layered map 800 includes sources of reaction. For instance, for an AMR 111 carrying an object, the overall resistance against the individual reaction type is already calculated in the dependency tree 700. This resistance can then be correlated with the reaction exposure of the grid cell at the current or planned AMR location. Hence, if the AMR 111 is carrying an inflammable object, the heat resistance of the object can be correlated with temperature stored in the grid cell. This provides a probability that a reaction is caused. With the known severity of the reaction the risk can be determined as follows:

$${R}_{reaction} = {P}_{reaction} ( x , y ) * {S}_{reaction} \qquad ( 11 )$$

To calculate the risk for an AMR 111 or a human, the probability that a reaction is caused is combined with the expected severity. This could be either the probability of causing a reaction with another object or with the environment itself. This risk can be used to optimize the AMR planning system and also to issue warnings to humans.

VI. Computing Device

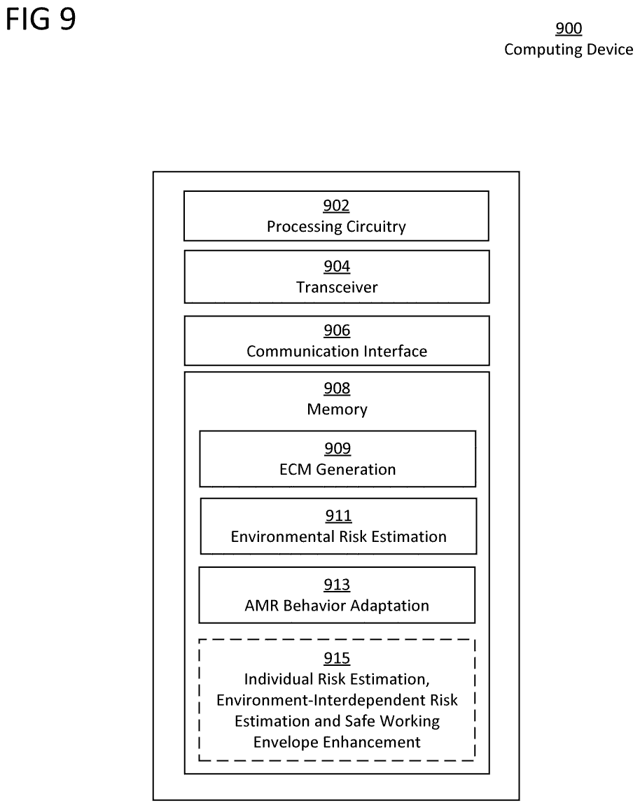

FIG. 9 illustrates a block diagram of an exemplary computing device in accordance with an aspects of the disclosure. In an aspect, the computing device 900 as shown and described with respect to FIG. 9 may be identified with a central controller and be implemented as any suitable network infrastructure component, which may be implemented as an Edge network server, controller, computing device, etc. As further discussed below, the computing device 900 may serve the environment 110 in accordance with the various techniques as discussed herein. Thus, the computing device 900 may perform the various functionality as described herein with respect to generating an environmental condition model (ECM) based on collected environmental attribute data of a physical environment, deploying the ECM to estimate environmental risk for an AMR 111 based on the environmental attribute data and a position of the AMR 111 within the physical environment, transmitting information related to the estimated environmental risk to the AMR 111 to adapt its operation to reduce operational risk, etc. To do so, the computing device 900 may include processing circuitry 902, a transceiver 904, communication interface 906, and a memory 908. The components shown in FIG. 9 are provided for ease of explanation, and the computing device 900 may implement additional, less, or alternative components as those shown in FIG. 9.

The processing circuitry 902 may be configured as any suitable number and/or type of computer processors, which may function to control the computing device 900. The processing circuitry 902 may be identified with one or more processors (or suitable portions thereof) implemented by the computing device 900. The processing circuitry 902 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 902 may be configured to carry out instructions to perform arithmetical, logical, and/or input/output (I/O) operations, and/or to control the operation of one or more components of computing device 900 to perform various functions as described herein. The processing circuitry 902 may include one or more microprocessor cores, memory registers, buffers, clocks, etc., and may generate electronic control signals associated with the components of the computing device 900 to control and/or modify the operation of these components. The processing circuitry 902 may communicate with and/or control functions associated with the transceiver 904, the communication interface 906, and/or the memory 908. The processing circuitry 902 may additionally perform various operations to control the communications, communications scheduling, and/or operation of other network infrastructure components that are communicatively coupled to the computing device 900.

The transceiver 904 may be implemented as any suitable number and/or type of components configured to transmit and/or receive data packets and/or wireless signals in accordance with any suitable number and/or type of communication protocols. The transceiver 904 may include any suitable type of components to facilitate this functionality, including components associated with known transceiver, transmitter, and/or receiver operation, configurations, and implementations. Although depicted in FIG. 9 as a transceiver, the transceiver 904 may include any suitable number of transmitters, receivers, or combinations of these that may be integrated into a single transceiver or as multiple transceivers or transceiver modules. The transceiver 904 may include components typically identified with an RF front end and include, for example, antennas, ports, power amplifiers (PAs), RF filters, mixers, local oscillators (LOs), low noise amplifiers (LNAs), up-converters, down-converters, channel tuners, etc.

The communication interface 906 may be configured as any suitable number and/or type of components configured to facilitate the transceiver 904 receiving and/or transmitting data and/or signals in accordance with one or more communication protocols, as discussed herein. The communication interface 906 may be implemented as any suitable number and/or type of components that function to interface with the transceiver 906, such as analog-to-digital converters (ADCs), digital to analog converters, intermediate frequency (IF) amplifiers and/or filters, modulators, demodulators, baseband processors, etc. The communication interface 906 may thus work in conjunction with the transceiver 904 and form part of an overall communication circuitry implemented by the computing device 900, which may be implemented via the computing device 900 to transmit commands and/or control signals to the AMRs 111 to execute any of the functions describe herein.

The memory 908 is configured to store data and/or instructions such that, when the instructions are executed by the processing circuitry 902, cause the computing device 900 to perform various functions as described herein. The memory 908 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 908 may be non-removable, removable, or a combination of both. The memory 908 may be implemented as a non-transitory computer readable medium storing one or more executable instructions such as, for example, logic, algorithms, code, etc.

As further discussed below, the instructions, logic, code, etc., stored in the memory 908 are represented by the various modules/engines as shown in FIG. 9. Alternatively, if implemented via hardware, the modules/engines shown in FIG. 9 associated with the memory 908 may include instructions and/or code to facilitate control and/or monitor the operation of such hardware components. In other words, the modules/engines as shown in FIG. 9 are provided for ease of explanation regarding the functional association between hardware and software components. Thus, the processing circuitry 902 may execute the instructions stored in these respective modules/engines in conjunction with one or more hardware components to perform the various functions as discussed herein.

The ECM generation module 909 may execute the functionality described herein as discussed with reference to the flowchart 200 for the generation of an environmental condition model (ECM) based on collected environmental attribute data of a physical environment.

The environmental risk estimation module 911 may execute the functionality described herein as discussed with reference to the flowchart 300 for the deployment of the ECM to estimate environmental risk for an AMR 111 based on the environmental attribute data and a position of the AMR 111 within the physical environment.

The AMR behavior adaptation module 913 may execute the functionality described herein as discussed with reference to the AMR behavior adaptation block 360 the transmission of information related to the estimated environmental risk to the AMR 111 to adapt its operation to reduce operational risk.

The individual risk estimation, environment-dependent risk estimation and safe working envelope enhancement module 915 may execute the functionality described herein as discussed with reference to the flowchart 600 for estimation of an individual risk of another agent or object in the physical environment, estimation of a potentially hazardous environment-dependent interdependency between the AMR 111 and the other agent or object, and enhancement of a safe working envelope of the AMR 111 due to the estimated interdependency.

The techniques of this disclosure may also be described in the following examples.

Example 1. A computing device, comprising: a memory configured to store computer-readable instructions; and processing circuitry configured to execute the computer-readable instructions to cause the computing device to: generate an environmental condition model (ECM) based on collected environmental attribute data of a physical environment; deploy the ECM to estimate environmental risk for an autonomous agent based on the environmental attribute data and a position of the autonomous agent within the physical environment; and transmit information related to the estimated environmental risk to the autonomous agent to adapt its operation to reduce operational risk.

Example 2. The computing device of example 1, wherein the ECM is deployed at least partially within the edge or the cloud.

Example 3. The computing device of example 1, wherein the processing circuitry is configured to execute the computer-readable instructions to cause the computing device to: store the estimated environmental risk information in a layer of the ECM.

Example 4. The computing device of example 1, wherein the processing circuitry is configured to execute the computer-readable instructions to cause the computing device to: represent the estimated environmental risk information in a form of a grid map of cells corresponding with the physical environment and having one or more layers corresponding with respective environmental attributes.

Example 5. The computing device of example 1, wherein the processing circuitry is configured to execute the computer-readable instructions to cause the computing device to: deploy the ECM to estimate the environmental risk on-the-fly for a physical environment location of interest.

Example 6. The computing device of example 1, wherein the processing circuitry is configured to execute the computer-readable instructions to cause the computing device to: update the ECM over time with additional collected environmental attribute data; and store measurement times of the respective collected environmental attribute data including the additional collected environmental attribute data.

Example 7. The computing device of example 1, wherein the collected environmental attribute data is sensed environmental attribute data combined with knowledge of a production process.

Example 8. The computing device of example 1, wherein the processing circuitry is configured to execute the computer-readable instructions to cause the computing device to: trigger, based on the collected environmental attribute data, a maintenance autonomous agent or a maintenance service to clean at least a portion of the physical environment on demand.

Example 9. The computing device of example 1, wherein the processing circuitry is configured to execute the computer-readable instructions to cause the computing device to: trigger, based on the collected environmental attribute data and a position of another agent within the physical environment, a warning about a dangerous condition.

Example 10. The computing device of example 1, wherein the collected environmental attribute data is based on a condition of a floor surface or a condition of air.

Example 11. The computing device of example 10, wherein the processing circuitry is configured to execute the computer-readable instructions to cause the computing device to: directly estimate the condition of the floor surface based on distance data collected from an odometer or acceleration data from an accelerometer of the autonomous agent, in combination with the autonomous agent's actual movement.

Example 12. The computing device of example 1, wherein the collected environmental attribute data is crowd-sourced attribute data from one or more autonomous agent sensors, one or more infrastructure sensors, or manually-reported condition information.

Example 13. The computing device of example 1, wherein the ECM factors in a temporal effect on an environmental attribute.

Example 14. The computing device of example 13, wherein the temporal effect is due to drying time or air flow and impacts estimated or measured drying model parameters or air flow parameters of the ECM.

Example 15. The computing device of example 1, wherein the processing circuitry is configured to execute the computer-readable instructions to cause the computing device to: estimate an individual risk of another agent or object in the physical environment; estimate a potentially hazardous environment-dependent interdependency between the autonomous agent and the other agent or object; and enhance a safe working envelope of the autonomous agent due to the estimated interdependency.

Example 16. The computing device of example 15, wherein the potentially hazardous environment-dependent interdependency between the autonomous agent and the other agent or object is based on a reactivity between the autonomous agent and the other agent or object.

Example 17. The computing device of example 16, wherein the reactivity is based on a material property or a physical environment position of the autonomous agent or the other agent or object.

Example 18. The computing device of example 16, wherein the reactivity is function of severity or probability of a reaction between the autonomous agent and the other agent or object.

Example 19. An edge network computing device, comprising: processing circuitry configured to execute the computer-readable instructions to cause the computing device to: generate an environmental condition model (ECM) based on collected environmental attribute data of a physical environment; and deploy the ECM to estimate environmental risk for an autonomous agent based on the environmental attribute data and a position of the autonomous agent within the physical environment; and a communication interface configured to transmit information related to the estimated environmental risk to the autonomous agent to adapt its operation to reduce operational risk.

Example 20. The edge network computing device of example 19, wherein the ECM is deployed at least partially within the edge or the cloud.

Example 21. The edge network computing device of example 19, wherein the processing circuitry is configured to execute the computer-readable instructions to cause the computing device to: store the estimated environmental risk information in a layer of the ECM.

Example 22. The edge network computing device of claim 19, wherein the processing circuitry is configured to execute the computer-readable instructions to cause the computing device to: estimate an individual risk of another agent or object in the physical environment; estimate a potentially hazardous environment-dependent interdependency between the autonomous agent and the other agent or object; and enhance a safe working envelope of the autonomous agent due to the estimated interdependency.

Example 23. The edge network computing device of example 22, wherein the potentially hazardous environment-dependent interdependency between the autonomous agent and the other agent or object is based on a reactivity between the autonomous agent and the other agent or object.

Example 24. A non-transitory computer-readable medium storing a program including instructions that, when executed by a computing device, cause the computing device to: generate an environmental condition model (ECM) based on collected environmental attribute data of a physical environment; deploy the ECM to estimate environmental risk for an autonomous agent based on the environmental attribute data and a position of the autonomous agent within the physical environment; and transmit information related to the estimated environmental risk to the autonomous agent to adapt its operation to reduce operational risk.

Example 25. The non-transitory computer-readable medium of example 24, wherein the ECM is deployed at least partially within the edge or the cloud.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A computing device, comprising:
a memory configured to store computer-readable instructions; and
processing circuitry configured to execute the computer-readable instructions to cause the computing device to:
generate an environmental condition model (ECM) based on collected environmental attribute data of a physical environment;
deploy the ECM to estimate environmental risk for an autonomous agent based on the environmental attribute data and a position of the autonomous agent within the physical environment; and
transmit information related to the estimated environmental risk to the autonomous agent to adapt its operation to reduce operational risk.

2. The computing device of claim 1, wherein the ECM is deployed at least partially within the edge or the cloud.

3. The computing device of claim 1, wherein the processing circuitry is configured to execute the computer-readable instructions to cause the computing device to:
store the estimated environmental risk information in a layer of the ECM.

4. The computing device of claim 1, wherein the processing circuitry is configured to execute the computer-readable instructions to cause the computing device to:
represent the estimated environmental risk information in a form of a grid map of cells corresponding with the physical environment and having one or more layers corresponding with respective environmental attributes.

5. The computing device of claim 1, wherein the processing circuitry is configured to execute the computer-readable instructions to cause the computing device to:
deploy the ECM to estimate the environmental risk on-the-fly for a physical environment location of interest.

6. The computing device of claim 1, wherein the processing circuitry is configured to execute the computer-readable instructions to cause the computing device to:
update the ECM over time with additional collected environmental attribute data; and
store measurement times of the respective collected environmental attribute data including the additional collected environmental attribute data.

7. The computing device of claim 1, wherein the collected environmental attribute data is sensed environmental attribute data combined with knowledge of a production process.

8. The computing device of claim 1, wherein the processing circuitry is configured to execute the computer-readable instructions to cause the computing device to:
trigger, based on the collected environmental attribute data, a maintenance autonomous agent or a maintenance service to clean at least a portion of the physical environment on demand.

9. The computing device of claim 1, wherein the processing circuitry is configured to execute the computer-readable instructions to cause the computing device to:
trigger, based on the collected environmental attribute data and a position of another agent within the physical environment, a warning about a dangerous condition.

10. The computing device of claim 1, wherein the collected environmental attribute data is based on a condition of a floor surface or a condition of air.

11. The computing device of claim 10, wherein the processing circuitry is configured to execute the computer-readable instructions to cause the computing device to:
directly estimate the condition of the floor surface based on distance data collected from an odometer or acceleration data from an accelerometer of the autonomous agent, in combination with the autonomous agent's actual movement.

12. The computing device of claim 1, wherein the collected environmental attribute data is crowd-sourced attribute data from one or more autonomous agent sensors, one or more infrastructure sensors, or manually-reported condition information.

13. The computing device of claim 1, wherein the ECM factors in a temporal effect on an environmental attribute.

14. The computing device of claim 13, wherein the temporal effect is due to drying time or air flow and impacts estimated or measured drying model parameters or air flow parameters of the ECM.

15. The computing device of claim 1, wherein the processing circuitry is configured to execute the computer-readable instructions to cause the computing device to:
estimate an individual risk of another agent or object in the physical environment;
estimate a potentially hazardous environment-dependent interdependency between the autonomous agent and the other agent or object; and
enhance a safe working envelope of the autonomous agent due to the estimated interdependency.

16. The computing device of claim 15, wherein the potentially hazardous environment-dependent interdependency between the autonomous agent and the other agent or object is based on a reactivity between the autonomous agent and the other agent or object.

17. The computing device of claim 16, wherein the reactivity is based on a material property or a physical environment position of the autonomous agent or the other agent or object.

18. The computing device of claim 16, wherein the reactivity is function of severity or probability of a reaction between the autonomous agent and the other agent or object.

19. An edge network computing device, comprising:
processing circuitry configured to execute the computer-readable instructions to cause the computing device to:
generate an environmental condition model (ECM) based on collected environmental attribute data of a physical environment; and
deploy the ECM to estimate environmental risk for an autonomous agent based on the environmental attribute data and a position of the autonomous agent within the physical environment; and
a communication interface configured to transmit information related to the estimated environmental risk to the autonomous agent to adapt its operation to reduce operational risk.

20. The edge network computing device of claim 19, wherein the ECM is deployed at least partially within the edge or the cloud.

21. The edge network computing device of claim 19, wherein the processing circuitry is configured to execute the computer-readable instructions to cause the computing device to:
store the estimated environmental risk information in a layer of the ECM.

22. The edge network computing device of claim 19, wherein the processing circuitry is configured to execute the computer-readable instructions to cause the computing device to:
estimate an individual risk of another agent or object in the physical environment;
estimate a potentially hazardous environment-dependent interdependency between the autonomous agent and the other agent or object; and
enhance a safe working envelope of the autonomous agent due to the estimated interdependency.

23. The edge network computing device of claim 22, wherein the potentially hazardous environment-dependent interdependency between the autonomous agent and the other agent or object is based on a reactivity between the autonomous agent and the other agent or object.

24. A non-transitory computer-readable medium storing a program including instructions that, when executed by a computing device, cause the computing device to:
generate an environmental condition model (ECM) based on collected environmental attribute data of a physical environment;
deploy the ECM to estimate environmental risk for an autonomous agent based on the environmental attribute data and a position of the autonomous agent within the physical environment; and
transmit information related to the estimated environmental risk to the autonomous agent to adapt its operation to reduce operational risk.

25. The non-transitory computer-readable medium of claim 24, wherein the ECM is deployed at least partially within the edge or the cloud.
